(19) United States
(12) Patent Application Publication
(10) Pub. No.: US 2016/0072853 A1
(43) Pub. Date: Mar. 10, 2016

(54) Discovery and Control of Remote Media Sessions

(71) Applicant: Microsoft Corporation, Redmond, WA (US)

(72) Inventors: Vincent Bellet, East Kirkland, WA (US); Scott Plette, Kirkland, WA (US); Cristian Matesan, Redmond, WA (US); Mike Loholt, Seattle, WA (US); Steven Wilssens, Bothell, WA (US); Luke Angelini, Seattle, WA (US)

(21) Appl. No.: 14/476,817

(22) Filed: Sep. 4, 2014

(51) Int. Cl. H04L 29/06; H04L 29/08

(52) U.S. Cl. CPC H04L 65/1059; H04L 65/604; H04L 67/125

(57) ABSTRACT

Example apparatus and methods concern a first device (e.g., smart phone, tablet, laptop) that may discover and control remote media sessions (e.g., movie, game, book, podcast) running on remote devices (e.g., smart television, game console). The first device may run a local shell process that interacts with a shell process or other process on a remote device. The local shell process may acquire information about exposed remote media sessions. The local shell process may present a user interface on the first device. The user interface may provide user interface elements (e.g., buttons) for controlling a remote media session. The user interface and user interface elements are native to the first device. The user interface may allow navigating (e.g., flipping) between multiple remote media sessions that are discovered. The local shell process may also discover media sessions local to the first device and include those sessions in the user interface.

### BACKGROUND

Computing devices continue to proliferate at astounding rates. Computing devices also continue to increase in power, functionality, and versatility. As computing devices grow and develop, the number and types of applications that are running also increases. Different applications tend to have different interfaces and different devices tend to have different interfaces. Users may become most comfortable with one type of interface on one type of device and shy away from other interfaces on other types of devices. The proliferation of devices and interfaces may complicate controlling applications running on different types of devices.

One type of application that is nearly ubiquitous on a wide variety of computing devices is a media player application. In a single home, a first child may have media sessions running on her laptop computer, on her tablet computer, and on her smart phone while a second child may have media sessions running on his game console and on his desktop computer. Simultaneously, one parent may have a media session running on his eBook reader and another parent may have a media session running on her smart television. That's a lot of media sessions on a lot of devices all in one local space, likely sharing a network connection.

Conventionally, each media session was a local session that ran on one device and was controlled by that one device. Each session may have had its own user interface that was specific to a type of device on which the session was running. Coordination and control of this many sessions on this many devices may have been problematic, if even possible at all, due to the local nature of each session. Yet such control may have been sought, for example, by a parent who wanted to make sure that his children were studying or only engaging in permitted activities at permitted times at permitted volumes. Additionally, the parent may have wished to optimize bandwidth usage for work-related activities or for their spouse's movie viewing experience. Conventionally, the parent might have had to locate the kids, locate their devices, control these devices or figure out how to get the kids to control the devices, and continually monitor the complicated scenario. This may have been difficult, if even possible at all, especially when the parent encountered new devices having new interfaces with which the parent is unfamiliar. This situation may be even more complicated in, for example, a classroom setting where multiple students have multiple devices (e.g., tablet, smart phone).

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods improve over conventional approaches by discovering and controlling remote media sessions from a single device. Example apparatus and methods allow a single device (e.g., parent's smart phone) to discover media sessions (e.g., game, movie, music, podcast) and then to control (e.g., start/stop, increase/decrease volume, increase/decrease bandwidth) the media sessions. Example apparatus and methods may perform the control using a shell user interface that is native to the single device. Thus, the parent may be able to discover the children's media sessions and his spouse's media session and then control those sessions using a single interface with which he is familiar rather than having to use multiple different interfaces on multiple different apparatus. For example, the parent may turn down the volume on his daughter's music session, stop his son's video game, and allocate additional network bandwidth to his wife's movie all from his smart phone using controls that are native to his smart phone and familiar to the user.

Example apparatus and methods may facilitate a user discovering and controlling media sessions (e.g., music, video, photo slideshow, game, podcast) not only on the device they are using but also on other devices connected to the same network or otherwise related. This connected experience may blur hardware boundaries to facilitate raising the productivity and connected experience of the device users. Conventionally, a media application may have implemented some transport controls and used its own protocol to discover and control local media sessions. This conventional approach produced a purely local result while causing a significant burden on the local application all while producing an inconsistent experience for users. Example apparatus and methods produce a consistent experience that is implemented at the shell level and thus produces no additional burden on a local application.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example first device discovering a media session on a second device.

FIG. 2 illustrates an example first device discovering media sessions on multiple second devices.

FIG. 3 illustrates an example first device controlling a media session on a second device.

FIG. 4 illustrates an example first device controlling media sessions on multiple second devices.

FIG. 5 illustrates an example method associated with discovery and control of remote media sessions.

FIG. 6 illustrates an example method associated with discovery and control of remote media sessions.

FIG. 7 illustrates an example cloud operating environment in which a device may discover and control remote media sessions.

FIG. 8 is a system diagram depicting an exemplary mobile communication device that may discover and control remote media sessions.

FIG. 9 illustrates an example apparatus that discovers and controls remote media sessions.

FIG. 10 illustrates an example apparatus that discovers and controls remote media sessions.

FIG. 11 illustrates an example user interface presented by a method or apparatus that discovers and controls remote media sessions.

### DETAILED DESCRIPTION

Example apparatus and methods provide a shell-based solution for discovering and controlling remote media sessions. In computer science, and as used herein, a “shell” is a process that provides a user interface for accessing a service of an operating system. An operating system may provide various services including, for example, file management, process management, communications, and other services. A shell may interact with an operating system kernel application programming interface (API) and other APIs (e.g., networking). A shell may manage a user-system interaction by providing input choices, detecting input events, and responding to those events. Example apparatus and methods may provide input choices concerning remote media sessions that are discovered by the shell-based solution. Since the shell is not part of the operating system and is not part of the media session, the shell may be crafted independently of both the operating system and the media session. Being independent of the media session that will be detected and controlled removes a programming burden from media player application developers. Being independent of the operating system removes a programming burden from operating system developers and maintainers.

Different media sessions may be associated with different media applications. For example, a media session may involve a movie, a game, a book, a song, a podcast, or other media. “Media session” as used herein refers to an instance of a process, thread, or other executable associated with presenting a piece of media. While different types of media may have different types of controls, all types of media and thus all types of media sessions may be abstracted to facilitate shell-based control. For example, many types of media being played in the media session may include a start/stop or play/pause abstraction. Other abstractions may include louder/softer, forward/backward, current location, and total media length. Additionally, all media may have some identifier (e.g., name) and may have some associated art (e.g., album cover, book cover).

Example apparatus and methods may discover media sessions on the local device on which the shell-based solution is running. Example apparatus and methods may also discover media sessions on devices remote from the device on which the shell-based solution is running. For example, remote media sessions may be detected on other apparatus on a network that the local apparatus is using. The remote media session may have registered as a local process on the remote device or may have otherwise provided information to the operating system on the remote device. The shell-based solution may request information from the remote devices concerning active media sessions. Acquiring information about a media session may be part of the discovery process. Information about the discovered media sessions may then be presented on the local device using controls that are familiar to the user of the local device. Example apparatus and methods may provide different outputs. For example, a comprehensive list of remote media sessions may be displayed as well as tools for navigating through the list. A specific media session may be selected from the list using user interface techniques (e.g., tap). A specific media session may also be selected by flipping through discovered sessions using, for example, a user interface icon (e.g., flipper).

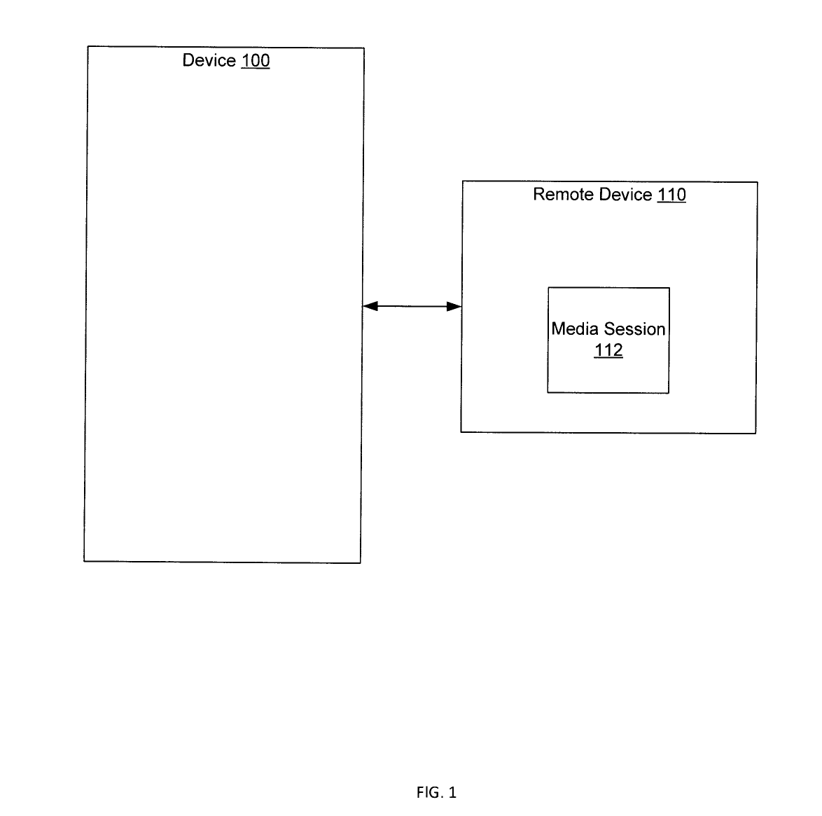

FIG. 1 illustrates a device 100 interacting with a remote device 110. A media session 112 is running on remote device 110. Example apparatus and methods facilitate device 100 locating information about media session 112. For example, information including the type of media (e.g., book, movie, game, podcast) may be acquired. Additionally, information including the length of the media, the current location in the media, whether the media is active or paused, artwork associated with the media, and other information may be acquired. In one embodiment, the media session 112 may only be discovered if remote device 110 has decided to expose its media sessions. In one embodiment, information about the media session 112 may only be acquired if the media session 112 has also decided to expose its information.

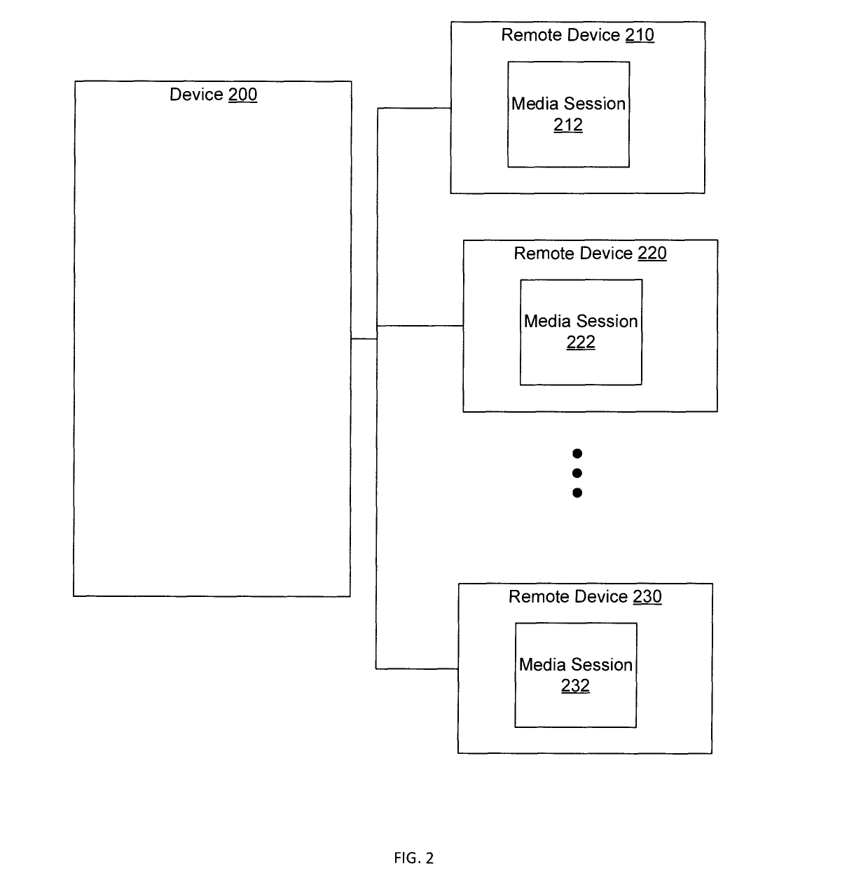

FIG. 2 illustrates a device 200 interacting with a plurality of remote devices. A first remote device 210 is running a first media session 212, a second remote device 220 is running a second media session 222, and an Nth remote device 230 is running an Nth media session 232, N being a number. The different remote devices may be different types of devices (e.g., smart phone, tablet, laptop, game console, smart television). The different media sessions may be associated with different types of media (e.g., movie, webinar, podcast, eBook, game).

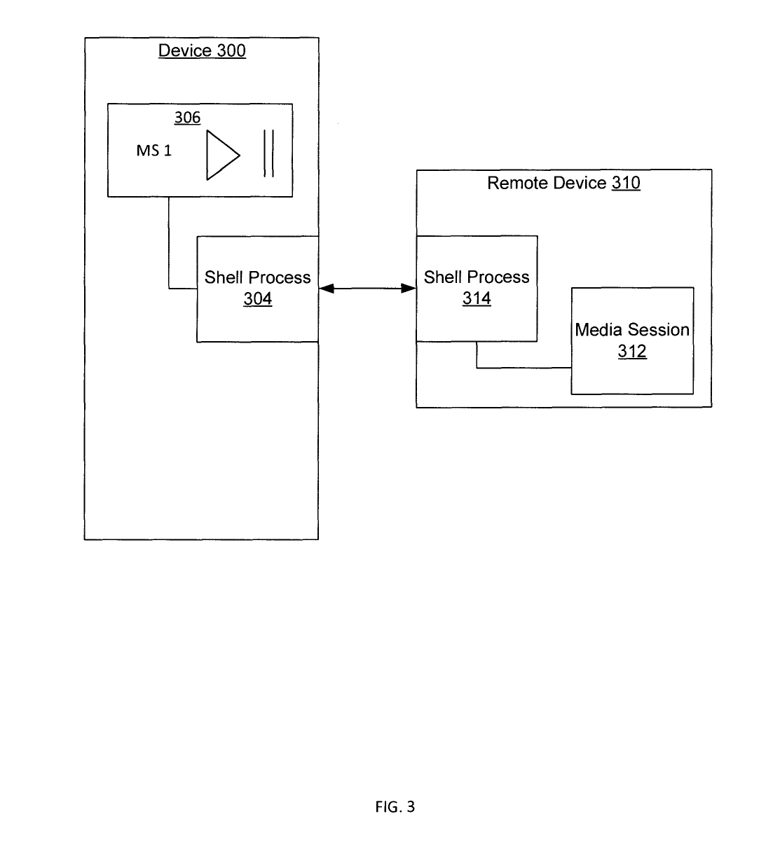

FIG. 3 illustrates a device 300 interacting with a remote device 310 on which a media session 312 is running. Device 300 has a shell process 304 that is interacting with a shell process 314 that is running on remote device 310. Shell process 314 may have information about media session 312. Shell process 304 may interact with shell process 314 to acquire the information about media session 312. Shell process 304 provides a user interface 306 that presents the information about media session 312. The user interface 306 provides user interface elements to control the media session 312. For example, the user interface 306 may provide a start button and a stop button. The user interface 306 may use icons and layouts that are native to device 300, rather than using icons and layouts that are native to media session 312.

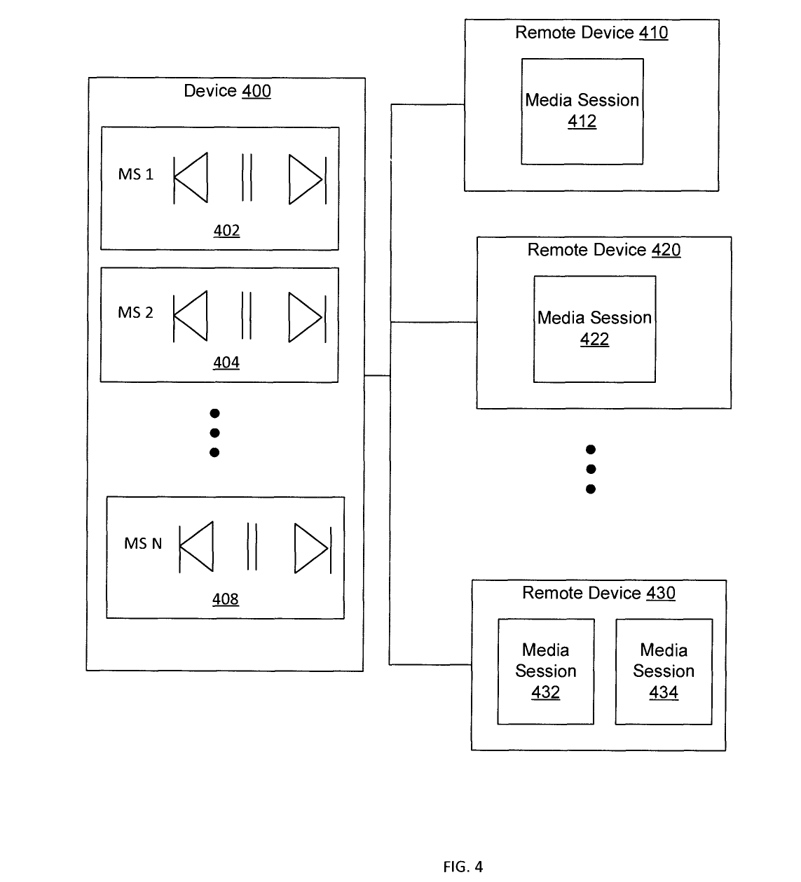

FIG. 4 illustrates a device 400 interacting with a plurality of remote devices. A first remote device 410 may be running a first media session 412, a second remote device 420 may be running a second media session 422, and an Nth remote device 430 may be running a media session 432 and an Nth media session 434, N being a number. Remote device 430, or other remote devices, may run one or more media sessions. The one or more media sessions may be for different types of media. Device 400 may be running a shell process and the remote devices may also be running shell processes. The shell process on device 400 may discover the media sessions on the remote devices and acquire information about the media sessions. The remote devices may be different types of devices and the media sessions may concern different types of media. Device 400 may present a user interface with user interface elements for controlling the discovered media sessions. For example, portion 402 of the user interface may provide forward, backward, and stop buttons for media session 412. Similarly, portion 404 may provide forward, backward, and stop buttons for media session 422 and portion 408 may provide forward, backward, and stop buttons for media session 434. While portions 402, 404, and 408 are illustrated displaying the same set of controls for the media sessions with which they are associated, different user interface portions may display different user interface elements (e.g., start, stop, forward, back, fast forward, pause, louder, quieter, more bandwidth, less bandwidth) that are appropriate to the type of media session being controlled.

While device 400 may present a user interface that includes information and controls for all discovered remote media sessions, in one embodiment, information about less than all the discovered remote media sessions may be presented. For example, information concerning a single remote media session may be presented and a user interface element may be provided to easily navigate between other discovered remote media sessions. In one embodiment, the user interface may also present information about a local media session or sessions.

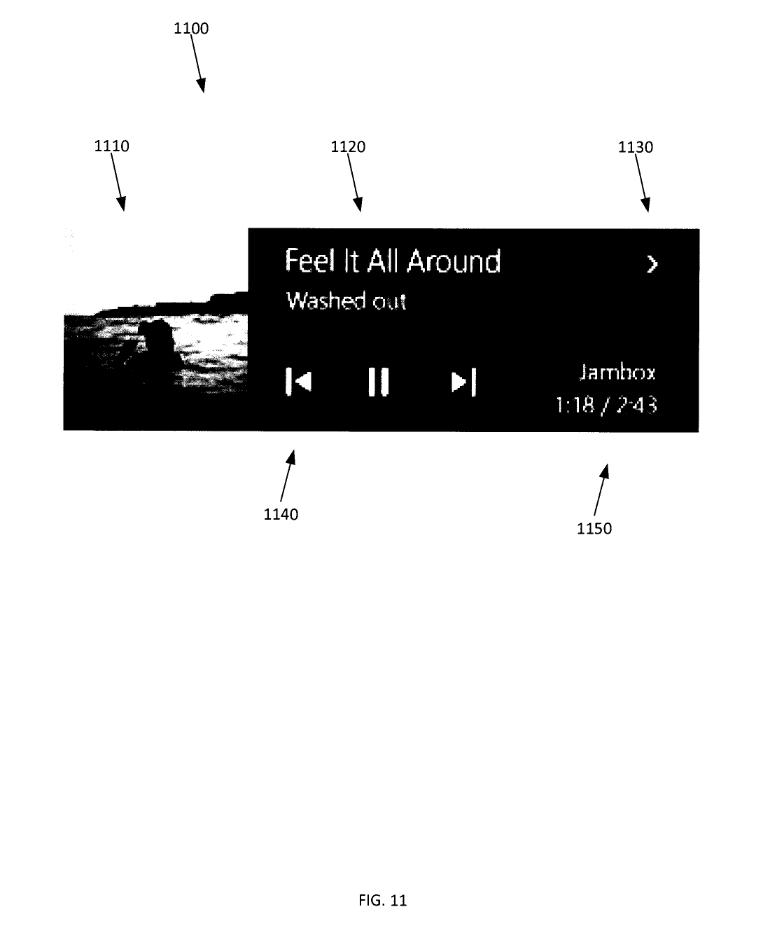

FIG. 11 illustrates a screen shot 1100 of an example user interface. This screen shot 1100 shows information about a single piece of media and provides a control 1130 for navigating to information about other pieces of media associated with other discovered remote media sessions. A thumbnail picture 1110 displays artwork associated with media currently being played. An information area 1120 may provide information (e.g., title, artist) about the media currently being played. Control 1130 facilitates navigating (e.g., flipping) to the next piece of media associated with the next remote media session. An information area 1150 provides information about the device on which the remote media session is playing (e.g., Jambox) and also provides information about the length of the media (e.g., 2:43) and a current location in the media (e.g., 1:18). User interface elements 1140 facilitate controlling the media. If the user activates control 1130 then a similar presentation may be made for another piece of media being played by another remote media session. Since the user may have a media session running on the device on which they are attempting to control other media sessions, in one embodiment, information about a local media session may also be presented.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

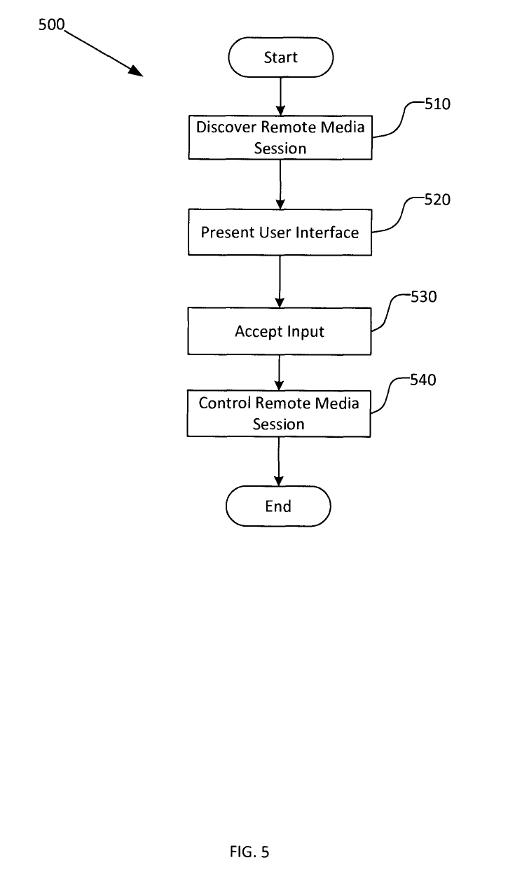

FIG. 5 illustrates an example method 500 for discovering and controlling remote media sessions. In one embodiment, method 500 may be performed in a shell process on a local computing device. In one embodiment, the local computing device and the remote computing device on which a remote media session is discovered are using the same computer network. While the local computing device and the remote computing device may use the same computer network, in one embodiment the devices may be on different networks. In one embodiment, the remote device is a Digital Living Network Alliance (DLNA) device and the shell process interacts with a DLNA service. Other types of generic, proprietary, or standards-based devices and services may be discovered and controlled.

Method 500 includes, at 510, discovering one or more remote media sessions running on one or more remote computing devices. In one embodiment, discovering a remote media session includes interacting with a shell process running on a remote computing device. Discovering a remote media session may include acquiring data about the remote media session. The data that is acquired about a remote media session may be data about a piece of media, data about a media session, or data about a device playing the piece of data. The data may identify the media as a piece of media or may identify a state associated with the piece of media. For example, the data about the media as media may include art associated with a piece of media, a name of the piece of media, or a duration of the piece of media. The data about the state of the media may include a current location in the piece of media, a remote computing device on which the piece of media is being presented, or other information. In one embodiment, discovering a remote media session includes locating a registration of a media session on an operating system associated with a remote device on the computer network.

Method 500 includes, at 520, presenting a user interface on the local computing device. The user interface presents data concerning the one or more remote media sessions that are discovered at 510. The user interface also includes one or more user interface elements for controlling the one or more remote media sessions. The user interface elements may include, for example, a start element, a stop element, a volume element, a change channel element, a bandwidth element, or other element. The user interface elements may be native to the local computing device. For example, buttons, sliders, menus, and events associated with actions (e.g., tap, double tap, swipe) performed on these elements may be provided by an operating system or user interface system on a device. Method 500 uses these built in elements and events. In one embodiment, the user interface includes a navigation element for selecting between the remote media sessions. The navigation element may be, for example, a flipper button that cycles through remote media sessions. In one embodiment, the user interface elements that are presented for a certain media session may be determined, at least in part, by the type of media. For example, a video game may have pause and volume controls while a movie may have start, stop, pause, forward, reverse, fast, slow, subtitle, and volume controls.

Method 500 also includes, at 530, accepting, through the user interface, an input for controlling a member of the one or more remote media sessions. The member may be associated with different types of media and different types of media players. For example, the member may be associated with a movie, a video game, an ebook, a song, a podcast, a webinar, or other media. Additionally, the member may be played on remote devices including a smart phone, a tablet computer, a laptop computer, a desktop computer, a game console, or other device.

Method 500 also includes, at 540, controlling the member based, at least in part, on the input. In one embodiment, controlling the member includes interacting with the shell process running on the remote computing device. Controlling the member may include starting a piece of media, pausing a piece of media, changing the volume at which the media is played, changing a frame rate available for the media, or other action.

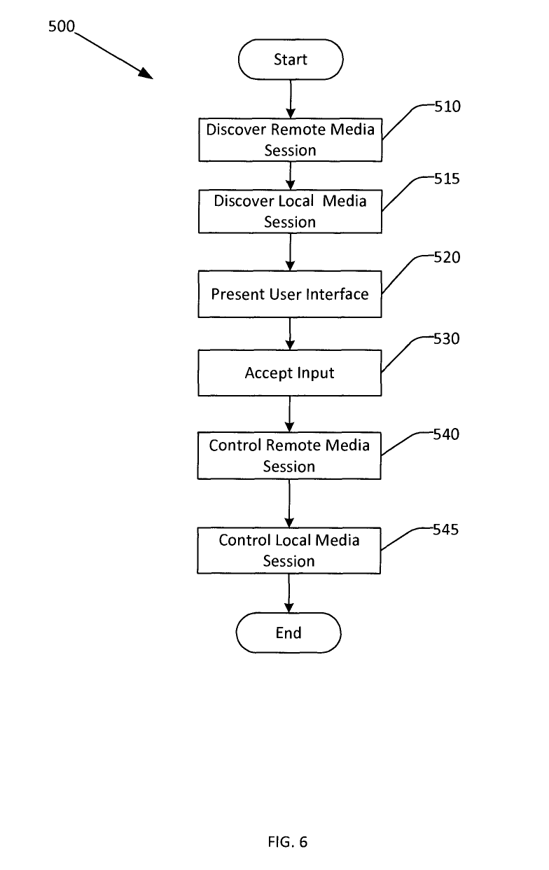

FIG. 6 illustrates another embodiment of method 500. This embodiment includes additional actions. For example, this embodiment includes, at 515, discovering one or more local media sessions running on the local computing device. The data concerning the local media sessions may be similar to the data concerning the remote media sessions. While the local media sessions are illustrated being discovered after the remote media sessions, the local media sessions may be discovered before or in parallel with the remote media sessions. Thus, data about the one or more local media sessions may be displayed at 520. Similarly, the user interface elements and actions for controlling a local media session may be similar to those associated with controlling a remote media session. Therefore, user interface elements may be presented at 520 and inputs may be accepted at 530.

This embodiment of method 500 may also include, at 545, controlling a local media session based, at least in part, on the input. Controlling the local media session may include, for example, starting a piece of media, stopping a piece of media, changing the volume at which media is played, changing a streaming rate for a media player, or other action.

While FIGS. 5 and 6 illustrate various actions occurring in serial, it is to be appreciated that various actions illustrated in FIGS. 5 and 6 could occur substantially in parallel. By way of illustration, a first process could control discovery of media sessions, a second process could control presentation of a shell based user interface to present information about the discovered media sessions, and a third process could facilitate controlling the media sessions. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer, phone, tablet) cause the machine to perform methods described or claimed herein including method 500. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

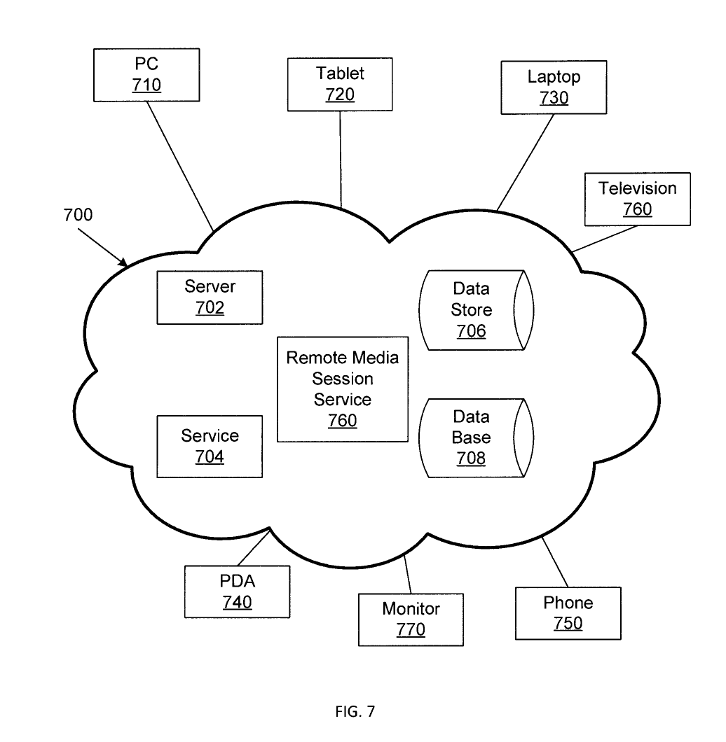

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example remote media session service 760 residing in the cloud 700. The remote media session service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the remote media session service 760.

FIG. 7 illustrates various devices accessing the remote media session service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. It is possible that different users at different locations using different devices may access the remote media session service 760 through different networks or interfaces. In one example, the remote media session service 760 may be accessed by a mobile device 750. In another example, portions of remote media session service 760 may reside on a mobile device 750. Remote media session service 760 may perform actions including, for example, discovering remote media sessions, presenting a user interface that displays information about discovered remote media sessions, controlling remote media sessions, or other actions. In one embodiment, remote media session service 760 may perform portions of methods described herein (e.g., method 500).

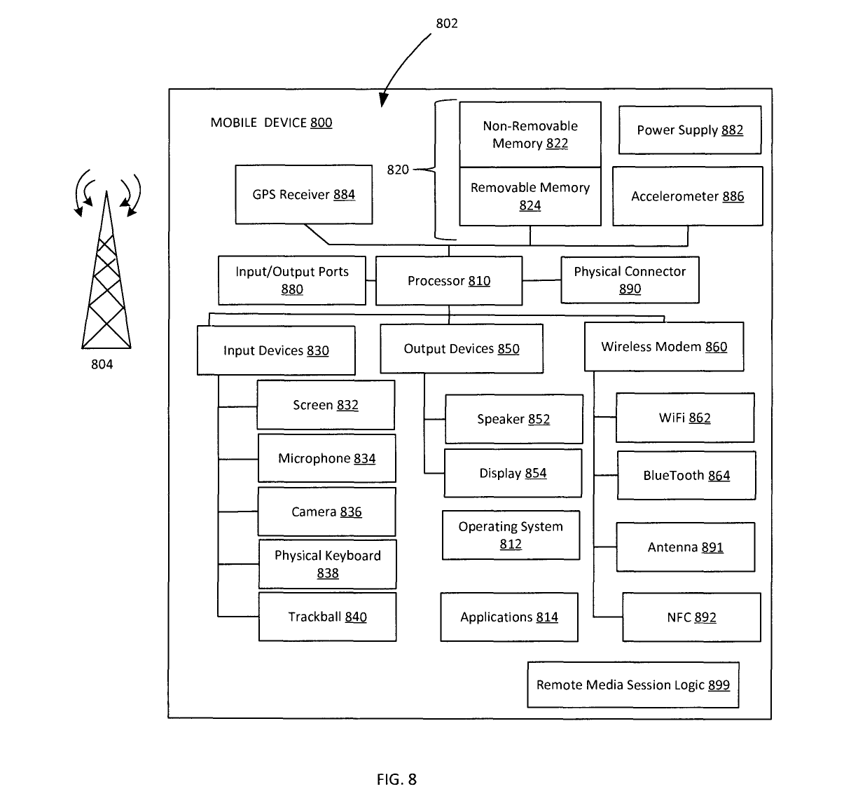

FIG. 8 is a system diagram depicting an exemplary mobile device 800 that includes a variety of optional hardware and software components shown generally at 802. Components 802 in the mobile device 800 can communicate with other components, although not all connections are shown for ease of illustration. The mobile device 800 may be a variety of computing devices (e.g., cell phone, smartphone, tablet, phablet, handheld computer, Personal Digital Assistant (PDA), etc.) and may allow wireless two-way communications with one or more mobile communications networks 804, such as a cellular or satellite networks. Example apparatus may concentrate processing power, memory, and connectivity resources in mobile device 800 with the expectation that mobile device 800 may be able to interact with other devices (e.g., tablet, monitor, keyboard) and provide remote media session control for those other devices.

Mobile device 800 can include a controller or processor 810 (e.g., signal processor, microprocessor, application specific integrated circuit (ASIC), or other control and processing logic circuitry) for performing tasks including input event handling, output event generation, signal coding, data processing, input/output processing, power control, or other functions. An operating system 812 can control the allocation and usage of the components 802 and support application programs 814. The application programs 814 can include media sessions, mobile computing applications (e.g., email applications, calendars, contact managers, web browsers, messaging applications), video games, movie players, television players, productivity applications, or other applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include remote media session identifiers, remote media session attributes, media identifiers, media attributes, control event data, web pages, text, images, sound files, video data, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment. The memory 820 may be sufficient to store remote media session information that may then be provided to a shell for use in a user interface.

The mobile device 800 can support one or more input devices 830 including, but not limited to, a screen 832 that is both touch and hover-sensitive, a microphone 834, a camera 836, a physical keyboard 838, or trackball 840. The mobile device 800 may also support output devices 850 including, but not limited to, a speaker 852 and a display 854. Display 854 may be incorporated into a touch-sensitive and hover-sensitive i/o interface. Other possible input devices (not shown) include accelerometers (e.g., one dimensional, two dimensional, three dimensional), gyroscopes, thermometers, barometers, light meters, and sound meters. Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting touch and hover gestures associated with controlling output actions.

A wireless modem 860 can be coupled to an antenna 891. In some examples, radio frequency (RF) filters are used and the processor 810 need not select an antenna configuration for a selected frequency band. The wireless modem 860 can support one-way or two-way communications between the processor 810 and external devices. The communications may concern media or media session data that is provided as controlled, at least in part, by remote media session logic 899. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a remote media session logic 899 that provides a functionality for the mobile device 800 and for interacting with remote media sessions. For example, remote media session logic 899 may provide a client for interacting with a service (e.g., service 760, FIG. 7). Portions of the example methods described herein may be performed by remote media session logic 899. Similarly, remote media session logic 899 may implement portions of apparatus described herein. In one embodiment, remote media session logic 899 may detect a remote media session, acquire information about the remote media session, present the information in a user interface, accept inputs from the user interface, and control the remote media session based on the inputs.

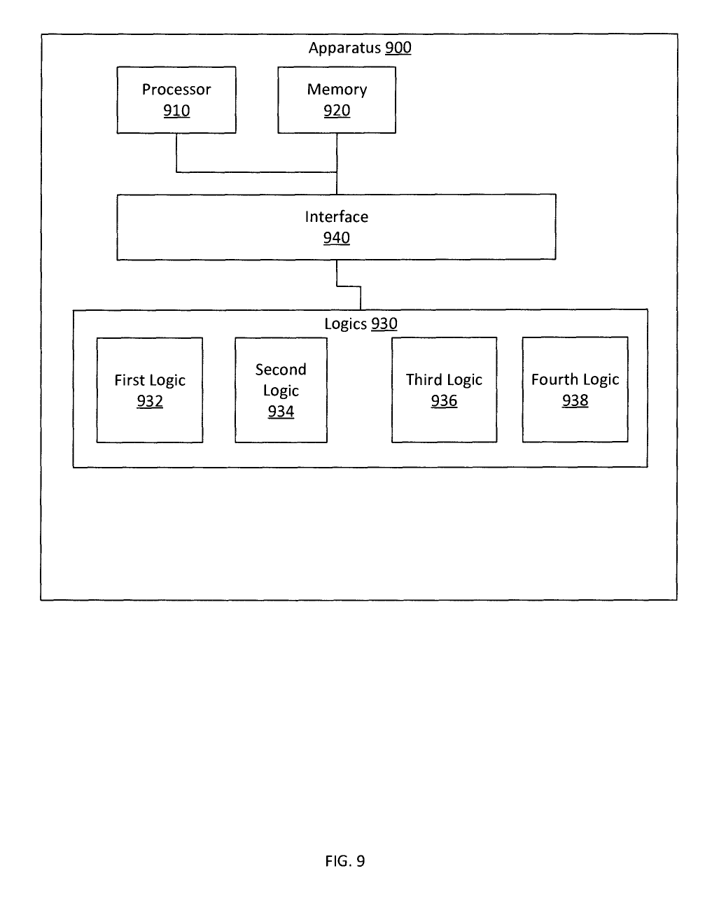

FIG. 9 illustrates an apparatus 900 that may discover and control remote media sessions. Apparatus 900 may be, for example, a smart phone, a laptop, a tablet, or other computing device. In one example, the apparatus 900 includes a physical interface 940 that connects a processor 910, a memory 920, and a set of logics 930. The set of logics 930 may facilitate discovering and controlling remote media sessions. More generally, the set of logics 930 may facilitate discovering and controlling instances of media applications running on other apparatus. Elements of the apparatus 900 may be configured to communicate with each other, but not all connections have been shown for clarity of illustration.

Apparatus 900 may include a first logic 932 that communicates between the apparatus 900 and a second apparatus on which an instance of a media application is running. In one embodiment, the first logic 932 communicates between the apparatus 900 and the second apparatus using a shell process. The shell process may provide an abstraction of an actual communication process between the apparatus 900 and the second apparatus. The abstraction facilitates reducing coding complexity because developers may code to the shell and the abstraction rather than coding to any specific protocol. The abstraction may define actions including, for example, read data from remote instance, and provide control signal to remote instance.

Apparatus 900 may include a second logic 934 that acquires information about the instance. The information about the instance may describe the media item, the media session, the media player, or the second apparatus. For example, the information may identify an identity (e.g., name, ISBN, GUID) of the media being presented by the instance, a type (e.g., movie, book, game) of media being presented by the instance, a duration of the media being presented by the instance, a present location in the media being presented by the instance, and a type of device (e.g., smart phone, tablet, game console) on which the media is being played. ISBN refers to international standard book number, GUID refers to globally unique identifier.

Apparatus 900 may include a third logic 936 that presents data about the instance using a shell process that provides a user interface for interacting with an abstraction of the instance. In one embodiment, the third logic 936 constructs the user interface from user interface elements local to the apparatus 900. For example, a smart phone may have a built-in set of touch events that are used to control applications. The smart phone may also have a built-in set of elements (e.g., button, slider, menu) that are presented in multiple different applications. The touch events may include tapping on a button, double tapping on a button, spreading on a picture, pinching on a picture, swiping a slider control, or other actions. The user interface provided by third logic 936 may use the user interface elements and events that are built in to the smart phone or provided by, for example, an operating system on the smart phone. Using built in elements, events, and controls reduces the learning curve for using apparatus 900 and reduces the amount of resources required to add the remote control functionality to apparatus 900.

Apparatus 900 may include a fourth logic 938 that controls the instance based, at least in part, on an interaction with the user interface. While different media players and different types of media may have different unique attributes, all media share some attributes and actions. For example, all media have a length and a current viewing/listening/reading location. Similarly, all media can be started or stopped. Thus, in one embodiment, the user interface elements provide a start functionality, a stop functionality, a volume functionality, a forward functionality, a reverse functionality, a change channel functionality, or a bandwidth control functionality. Other functionalities may be provided. In one embodiment, the user interface may only display functionality that is relevant to a media session.

Apparatus 900 may provide superior results when compared to conventional systems because the user has access to remote media sessions as well as local media sessions and may exercise control over the media sessions more easily. A parent may no longer need to tell a child to turn down the volume because the parent may be able to remotely control the device. Similarly, a person who is deemed to be the “keeper of the bandwidth” may be able to allocate bandwidth to different media sessions from a single location. For example, a user may change a viewing experience from 1200 dpi to 300 dpi or may change a frame rate. A person may not have to learn multiple different interfaces to multiple different applications on multiple different machines to be able to control and coordinate a presentation. For example, a play producer may be able to control several media players all at the same time from a single device, all using an interface that is native to the single device. In one embodiment, which may be useful to, for example, a school teacher, the apparatus 900 may be able to simultaneously control a set or even all remote media sessions. For example, a teacher may be able to pause all media sessions in a classroom using a single interaction with the user interface, give an instruction, and then restart all the media sessions using another single interaction with the user interface.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store remote media session data, user interface data, control data, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions.

In one embodiment, the apparatus 900 may be a general purpose computer that has been transformed into a special purpose computer through the inclusion of the set of logics 930. Apparatus 900 may interact with other apparatus, processes, and services through, for example, a computer network.

In one embodiment, the functionality associated with the set of logics 930 may be performed, at least in part, by hardware logic components including, but not limited to, field-programmable gate arrays (FPGAs), application specific integrated circuits (ASICs), application specific standard products (ASSPs), system on a chip systems (SOCs), or complex programmable logic devices (CPLDs).

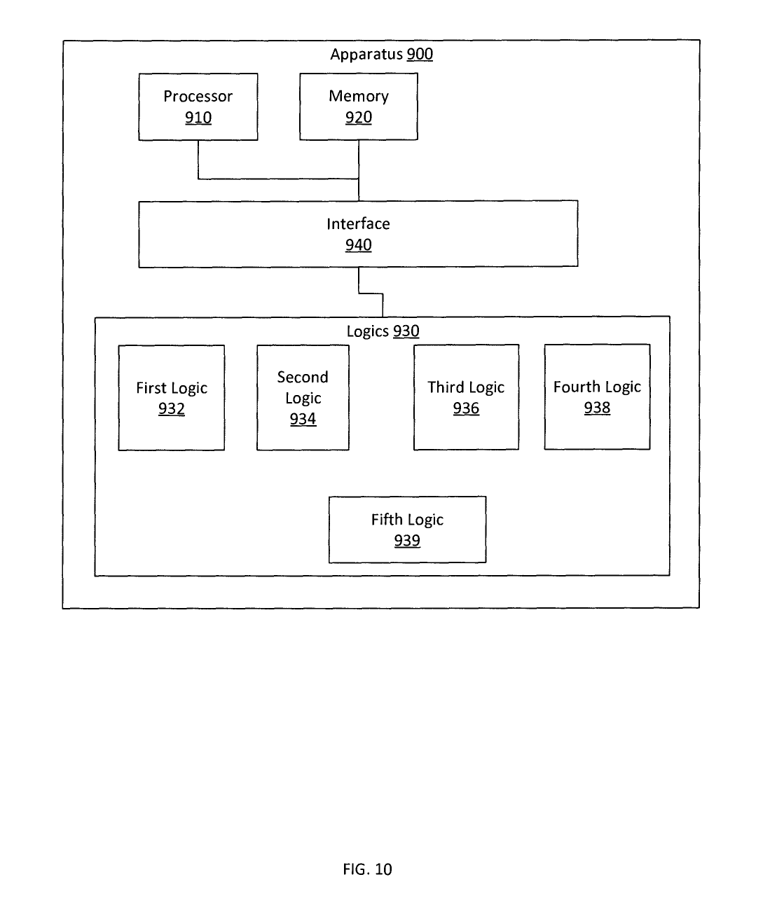

FIG. 10 illustrates another embodiment of apparatus 900. This embodiment of apparatus 900 includes a fifth logic 939 that acquires information about a local instance of a media application running on the apparatus 900. When information about local instances is also available, then the third logic 936 may also present data about the local instance using the shell process. Similarly, the fourth logic 938 may control the local instance based, at least in part, on an interaction with the user interface. Note that the media sessions are not being linked, and that apparatus 900 is not sharing the media experience with the remote devices. Apparatus 900 is just allowing remote control of multiple media sessions using an interface that is native to apparatus 900.

### Aspects of Certain Embodiments

In one embodiment, an apparatus includes a processor, a memory, and a set of logics. The apparatus may include a physical interface to connect the processor, the memory, and the set of logics. The set of logics includes a first logic that communicates between the apparatus and a second apparatus on which an instance of a media application is running. The set of logics also includes a second logic that acquires information about the instance. The information about the instance may describe the media item, the media player, or the second apparatus. The set of logics also includes a third logic that presents data about the instance using a shell process that provides a user interface for interacting with an abstraction of the instance. The apparatus may also include a fourth logic that controls the instance based, at least in part, on an interaction with the user interface. The apparatus may also include a fifth logic that acquires information about a local instance of a media application running on the apparatus. When information about local instances is also available, then the third logic may also present data about the local instance using the shell process. Similarly, the fourth logic may control the local instance based, at least in part, on an interaction with the user interface.

In another embodiment, a system includes a smart phone and a game console. In this system, a shell process running on the smart phone identifies a media session associated with the game console. The shell process also presents a graphical user interface for controlling the media session. The graphical user interface includes user interface elements that are local to the smart phone. The user interface elements correspond to functionality available on the game console for the media session.

In another embodiment, a method performed on a local computing device may include discovering a remote media session running on a remote computing device. Discovering the remote media session may include acquiring information about the remote media session. Local media sessions may also be discovered. The method may also include presenting a user interface on the local computing device. The user interface includes data concerning a remote media session and user interface elements for controlling the remote media session. The method may also include accepting, through the user interface, an input for controlling a remote media session. Once an input has been received, the method may proceed by controlling the member based, at least in part, on the input. Local sessions may also be controlled.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

1. A method performed on a local computing device, the method comprising:
discovering one or more remote media sessions running on one or more remote computing devices, where discovering a remote media session includes acquiring data concerning the remote media session;
presenting a user interface on the local computing device, where the user interface includes data concerning the one or more remote media sessions and one or more user interface elements for controlling the one or more remote media sessions;
accepting, through the user interface, an input for controlling a member of the one or more remote media sessions, and
controlling the member based, at least in part, on the input,
where a remote media session has its own user interface that is specific to the remote computing device on which the remote media session is running, and
where the remote media session is a non-served session that is registered as a local process on the remote device.

2. The method of claim 1, where the method is performed in a shell process on the local computing device, and where discovering a remote media session includes interacting with a shell process running on a remote computing device.

3. The method of claim 2, where controlling the member includes interacting with the shell process running on the remote computing device.

4. The method of claim 2, where the one or more user interface elements include a start element, a stop element, a volume element, a change channel element, or a bandwidth element, and where the one or more user interface elements are native to the local computing device.

5. The method of claim 2, where the one or more user interface elements are selected based, at least in part, on the data concerning the one or more remote media sessions.

6. The method of claim 2, where the member is associated with a movie, a video game, an ebook, a song, a podcast, or a webinar, and where the one or more remote devices include a smart phone, a tablet computer, a laptop computer, a desktop computer, a television, or a game console.

7. The method of claim 2, where the user interface includes a navigation element for selecting between the one or more remote media sessions.

8. The method of claim 2, where the data concerning the remote media session includes art associated with a piece of media, a name of the piece of media, a duration of the piece of media, a current location in the piece of media, or a remote computing device on which the piece of media is being presented.

9. The method of claim 2, where the local computing device and the one or more remote computing devices are using the same computer network.

10. The method of claim 9, where discovering a remote media session includes locating a registration of a media session on an operating system associated with a remote device on the computer network.

11. The method of claim 2, comprising:
discovering one or more local media sessions running on the local computing device;
displaying data in the user interface concerning the one or more local media sessions;
presenting one or more user interface elements for controlling the one or more local media sessions;
accepting, through the user interface, a local input for controlling a member of the one or more local media sessions, and
controlling the member of the one or more local media sessions based, at least in part, on the local input.

12. The method of claim 2, comprising controlling two or more remote media sessions simultaneously in response to a single user interface input.

13. The method of claim 2, where the remote device is a Digital Living Network Alliance (DLNA) device and where the shell process interacts with a DLNA service.

14. An apparatus, comprising:
a processor;
a memory;
a set of logics that facilitate discovering and controlling instances of media applications running on other apparatus, and
a physical interface to connect the processor, the memory, and the set of logics,
the set of logics comprising:
a first logic that communicates between the apparatus and a second apparatus on which an instance of a media application is running;
a second logic that acquires information about the instance;
a third logic that presents data about the instance using a shell process that provides a user interface for interacting with an abstraction of the instance, and
a fourth logic that controls the instance based, at least in part, on an interaction with the user interface,
where the instance of the media application is a non-served instance that is registered as a local process on the second apparatus.

15. The apparatus of claim 14, where the first logic communicates between the apparatus and the second apparatus using a shell process that provides an abstraction of an actual communication process between the apparatus and the second apparatus.

16. The apparatus of claim 15, where the information about the instance identifies an identity of the media being presented by the instance, a type of media being presented by the instance, a duration of the media being presented by the instance, a present location in the media being presented by the instance, or a type of device on which the media is being played.

17. The apparatus of claim 16, where the third logic constructs the user interface from user interface elements local to the apparatus, and where the user interface elements provide a start functionality, a stop functionality, a volume functionality, a forward functionality, a reverse functionality, a change channel functionality, or a bandwidth control functionality.

18. The apparatus of claim 17, where the third logic selects user interface elements for the user interface based, at least in part, on information about the instance, and where the fourth logic simultaneously controls two or more instances based on a single user interaction with the user interface.

19. The apparatus of claim 14, comprising a fifth logic that acquires information about a local instance of a media application running on the apparatus,
where the third logic presents data about the local instance using the shell process, and
where the fourth logic controls the local instance based, at least in part, on an interaction with the user interface.

20. A system, comprising:
a smart phone, and
a game console,
where a shell process running on the smart phone identifies a media session associated with the game console, and
where the shell process presents a graphical user interface for controlling the media session, where the graphical user interface comprises user interface elements that are local to the smart phone, and where the user interface elements correspond to functionality available on the game console for the media session.
